(19) United States
(12) Patent Application Publication
(10) Pub. No.: US 2005/0259437 A1
(43) Pub. Date: Nov. 24, 2005

(54) Apparatus, systems and methods relating to illumination for microscopes

(76) Inventors: Gerald L. Klein, Edmonds, WA (US); Phillip Freund, Seattle, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 11/132,871

(22) Filed: May 18, 2005

Related U.S. Application Data
(60) Provisional application No. 60/572,893, filed on May 19, 2004.

(51) Int. Cl. G02B 21/06

(52) U.S. Cl. 362/602

(57) ABSTRACT

Systems, apparatus and methods pertaining generally, in some embodiments, to improved illumination for microscopes. For example, certain embodiments relate to the use of an array of multiple wavelength light-emitting diodes that are coupled to an integrating sphere. Light exiting the sphere is relayed using a fused fiber optic bundle. The systems, etc., effectively improve the illumination system over the traditional illumination system used by most microscope manufacturers, and can be particularly useful when applied to photomicrography.

### CROSS-REFERENCE TO RELATED APPLICATIONS

The present application claims priority from U.S. provisional patent application No. 60/572,893, filed May 19, 2004, which is incorporated herein by reference in its entirety and for all its teachings and disclosures.

### BACKGROUND

Modern compound microscopes make use of specialized combinations of lenses to take advantage of the maximum resolving power of the instrument. While much of the resolving power resides with the objective lenses, another important component is the illumination system that supplies light to or through a specimen and is collected by the objective lens. The quality of light entering into the objective is preferably uniformly bright and of a uniform color temperature so as to provide a flat field of illumination. The angle at which light passes through a specimen and is collected by the objective is also preferably at least equal, in terms of numerical aperture, to the angle that an objective lens is capable of collecting incident light, in order to realize maximum resolving power. In one approach to meet these conditions, manufacturers of simple brightfield microscopes make use of a system of illumination known in the art as Köhler illumination, which was devised by August Köhler in 1893. The modern implementation of Köhler's system generally has two major elements: A filament lamp, and a system of lenses to relay the light to the objective lens. Exemplary Kohler systems are discussed, for example, in US2004027658, US6369939, CN1287625, JP2003029158, and US2003165011.

The light source typically used in modern microscopes is an incandescent lamp. Such a lamp has a tungsten filament within a fused silica globe, which is filled with a halogen gas. When electricity is applied to the filament, it emits intense light at a color temperature that varies with the voltage applied; typically about 3500° Kelvin. The light is often converted to a color temperature of about 5500° Kelvin, which is similar to the color temperature emitted by the sun, using a special filter known as a daylight filter, which is applied later in the optical path of the microscope. The amount of light that reaches the objective lens comes from a segment of filament that is on the order of 0.1 square inches.

When the lamp is used, the high temperature of the filament causes tungsten atoms to sublime from the filament surface, causing its diameter to be reduced. At some point, the filament breaks, causing the lamp to fail. The free atoms of tungsten that boil off are deposited onto the inner surface of the globe, forming a dark film. The film obscures light emission, causing the lamp to become darker as it ages. Increasing the electrical voltage typically compensates the loss of lamp intensity. However, this has the effect of shifting the wavelengths of the emitted light toward the red end of the spectrum. While this is generally not a problem for the human eye, it can be a problem in digital photomicroscopy, for example because it affects the white balance of a camera.

The other element of Köhler illumination is the system of lenses, which collect and relay emitted light to the specimen. The optical path to the objective typically comprises, first, of a series of lenses that collect the light. A diffusion filter is often present to re-distribute light from the glowing filament, resulting in more uniform illumination. A number of filters such as daylight filters may be applied to convert the color temperature to a more sun-like 5500° Kelvin. Additionally, neutral density filters may be included which attenuate the intensity of the light without shifting the color. Bandpass filters may be added, which may act to filter out undesirable wavelengths of light, or may act to enhance the contrast of a particular feature.

The light is then directed; sometimes by way of a directional mirror, to a sub-stage condenser. The sub-stage condenser is a set of lenses that may be variably focused to fill the back focal plane of the objective lens with image forming light. The condenser is aligned such that it is parcentric with the objective lens. The condenser is positioned at a particular distance from the objective so that substantially all of the light being relayed is focused at a single junction at back plane of the objective. Also, the cone of light reaching the objective lens, which is a function of the lens's numerical aperture, should completely fill the field of view. This is accomplished by adjusting a diaphragm that is integral with the condenser.

The correct adjustment of the sub-stage condenser is an important variable in the illumination system, for example to optimize the resolving power of the instrument. Since each objective lens on the microscope will have different light collecting properties, the adjustment of the condenser will vary with each objective. In order to maintain correct Köhler illumination for each objective, the condenser is usually re-adjusted each time a different objective is placed in the optical path.

The microscope was created in order to aid the human eye. Of recent, digital cameras are increasingly being used in conjunction with the microscope as a means to record observations. However, advances in photomicroscopy have sometimes outpaced changes to the basic microscope system, and systems that at one time were adequate for human vision are inadequate for the new generation of digital cameras that are being utilized. For example, digital cameras are much more sensitive to changes in lighting intensity distribution. Shifts in illumination wavelength and distribution manifest as imaging artifacts.

Thus, there has gone unmet a need for improved apparatus, systems and methods to make improved use of new imaging technologies, for example improved the white balance of illumination light over the course of time for a microscope. The present systems and methods provide these and/or other advantages.

### SUMMARY

The present systems, apparatus and methods pertain generally, in some embodiments, to improved illumination for microscopes. For example, certain embodiments relate to the use of an array of multiple wavelength light-emitting diodes that are coupled to an integrating sphere. Light exiting the sphere is relayed using a fused fiber optic bundle. The systems, etc., effectively improve the illumination system over the traditional illumination system used by most microscope manufacturers, and can be particularly useful when applied to photomicrography.

These and other aspects, features and embodiments are set forth within this application, including the following Detailed Description and attached drawings. In addition, various references are set forth herein, including in the Cross-Reference To Related Applications, that discuss certain systems, apparatus, methods and other information; all such references are incorporated herein by reference in their entirety and for all their teachings and disclosures, regardless of where the references may appear in this application.

### BRIEF DESCRIPTION OF THE DRAWINGS

FIG. 1 depicts a side view of a schematic figure of a portion of a microscope image-capture system.

FIG. 2 depicts the microscope image-capture system of FIG. 1 with an illumination system for microscopy that includes an illumination device and an illumination controller.

FIGS. 3A and 3B depict side and plan views, respectively, of an illumination device comprising a light-integrating device, a plurality of input ports and an output port.

### DETAILED DESCRIPTION

The present systems, etc., related to providing substantially non-varying, even light for image detection systems such as microscopes, including for example digital imaging microscopes comprising a digital image detector such as a CCD, CID, or other pixilated imaging device. Other suitable imagers can also be used. The systems typically also provide light sources that do not substantially degrade for an extended period during use, sometimes extending substantially non-degraded for substantially the life of the light source. In the following detailed description of exemplary embodiments, reference is made to the accompanying drawings, which form a part hereof. Other embodiments may be utilized, and other changes may be made, without departing from the spirit or scope of the discussion herein. For example, the systems, etc., can be used in photographic applications, for example for projection of an image onto a target, such as in an enlarger. This aspect can be implemented, if desired, by shining red, blue and green light through a color negative and onto photographic paper. Further, as LEDs or other suitable light sources become brighter, use of LEDs in projection applications may become more commonplace.

The following detailed description is therefore not to be taken in a limiting sense, and the scope of the present application is defined by the appended claims.

In one embodiment, the illumination apparatus comprises a plurality of light-emitting devices that each emit light having frequencies that peak about a single frequency, the light-emitting devices each being optically coupled to the at least one input port of a light-integrating device comprising the at least one light input port and at least one output port. (Unless expressly stated otherwise or clear from the context, all embodiments, aspects, features, etc., discussed herein can be mixed and matched, combined and permuted in any desired manner.) The light-integrating device receives light at the at least one input port and outputs a substantially integrated light at the at least one output port. At least one optical fiber receives the substantially integrated light from the at least one output port and provides it to a target, and a controller controls the illumination emitted from at least one of the plurality of light-emitting devices.

The light-integrating device can be an integrating sphere, and may provide the substantially uniform light flux without using a lens. The frequencies of light emitted by at least two of the light-emitting devices can strongly peak about the single frequency, and the frequency of the light emitted by the at least one light-emitting device can have a main emission peak that is not more than approximately 130 nm wide, or other widths as may be desired. In some embodiments, the frequencies of light emitted by a first one of the light-emitting devices peaks about a first frequency and the frequencies of light emitted by a second one of the light-emitting devices peaks about a second different frequency.

The single frequency of the light can be either visible or not visible to a human eye. The at least one light-emitting device can be a light-emitting diode, a light-emitting laser or other light source that otherwise meets the criteria herein. The optical guide can be an optical fiber such as a fiber bundle or a fused fiber bundle, which can comprise a randomized fiber optic cable.

In another aspect, the embodiments comprise methods of providing a target illumination light to a microscope. The methods can comprise, generating a signal to activate a plurality of light-emitting devices such as semi-conductor light-emitting devices to emit light, each light-emitting device emitting light having frequencies that peak about a single frequency, activating or otherwise modulating the plurality of semiconductor light-emitting devices to emit light; substantially integrating the light from the plurality of semiconductor light-emitting devices; outputting the substantially integrated light; transmitting the outputted substantially integrated light to a target positioned for viewing via the microscope, using at least one optical light guide; and, deactivating the plurality of light-emitting devices.

In certain embodiments, the frequencies of light emitted by a first one of the light-emitting devices peaks about a first frequency and the frequencies of light emitted by a second one of the light-emitting devices peaks about a second different frequency. In various embodiments, the substantially-integrating is performed without using a lens. The present disclosure further includes methods of microscopy and other imaging methods comprising use of light produced according to the methods and/or using the devices, etc., discussed herein.

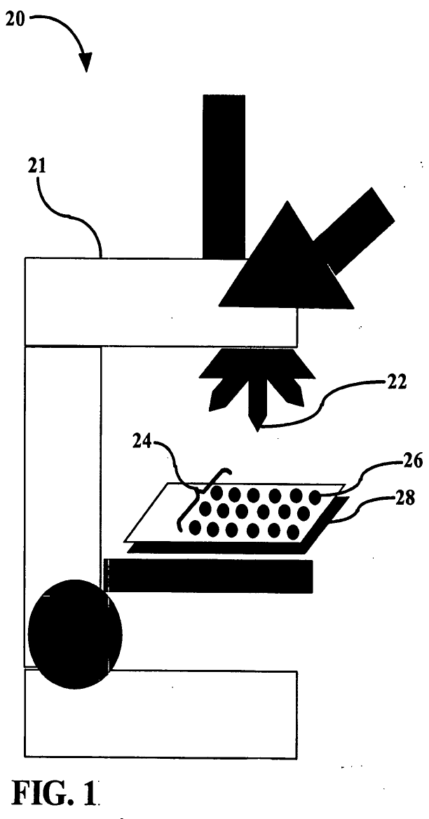

Turning to the figures, FIG. 1 illustrates a portion of a microscope image-capture system 20 that includes a microscope 21 having a lens 22 focused on a sample, such as a tissue-sample section 26 of a tissue microarray 24 mounted on a microscope slide 28. The microscopic slide 28 can have a label attached to it (not shown) for identification of the slide, such as a commercially available barcode label. The microscope 21 may be a robotic microscope having a camera (not shown), and may include a computer (not shown) that operates the microscope, which can include controlling the imaging, focusing, specimen identification (such as tissue identification), etc. Tissue samples, such as tissue sample 26, can be mounted by any method onto the microscope slide 28. Tissues can be fresh or immersed in fixative to preserve tissue and tissue antigens, and to avoid postmortem deterioration.

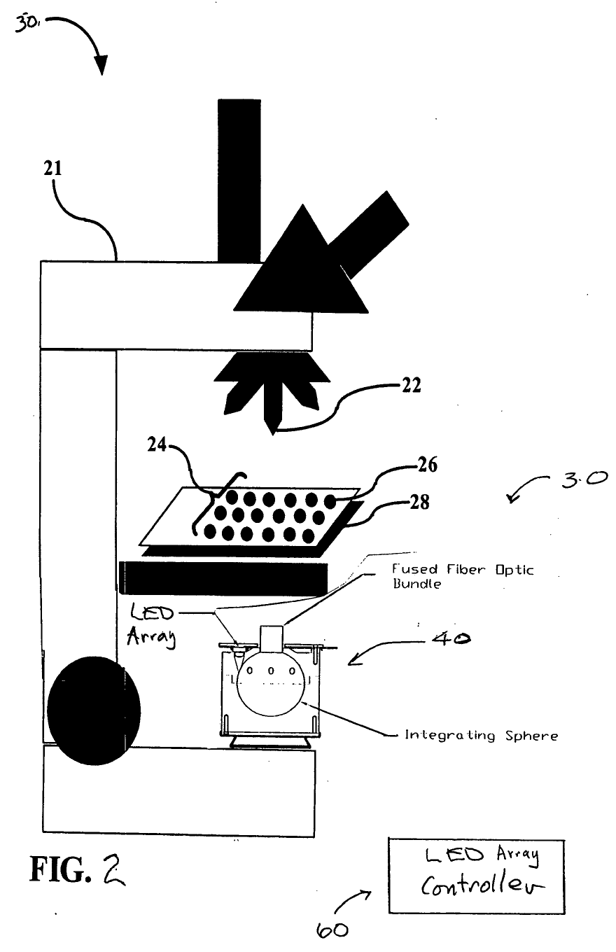

FIG. 2 illustrates an embodiment comprising the microscope image-capture system 20 of FIG. 1 with an illumination system 30 for microscopy that includes an illumination device 40 operably connected to an illumination controller 60. Illumination from the illumination system 30 brightly and evenly illuminate an object being observed through the microscope 21, such as the tissue sample 26. The illumination system 30 may be used in any form of microscopy, such as transmitted, reflective, and fluorescence microscopy. FIG. 2 illustrates an embodiment for transmitted microscopy (sometimes called brightfield microscopy) where illumination passes through the object and is received by the lens 22. In some embodiments a slightly different configuration of the illumination system 30 can be used for reflective or fluorescence microscopy, where the illumination is introduced into the lens of the microscope 21 for excitation or reflection.

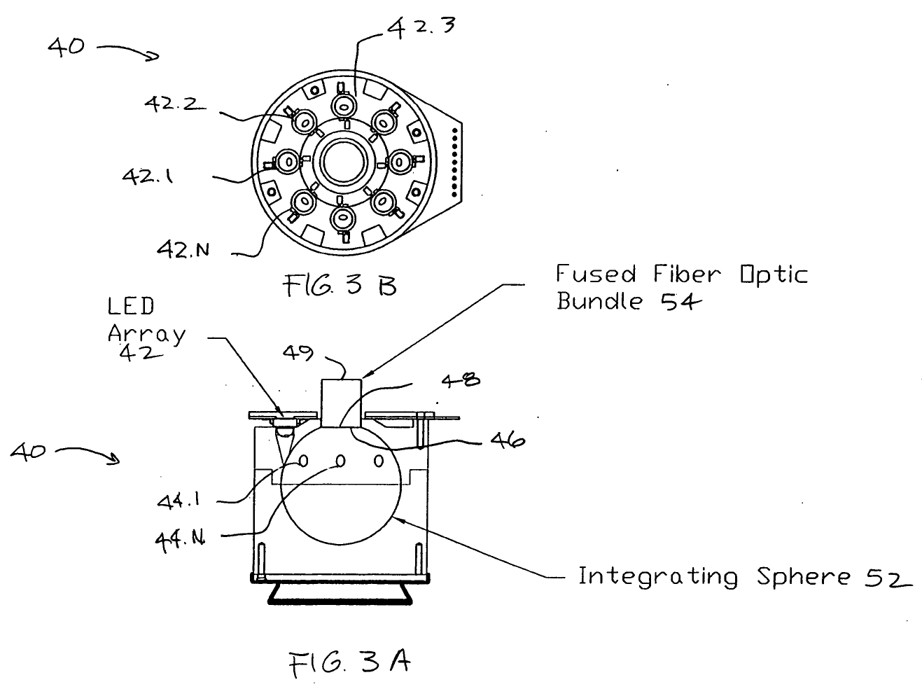

FIGS. 3A and 3B illustrate side and plan views, respectively, of an embodiment of the illumination device 40. The illumination device 40 includes a light-integrating device, illustrated as an integrating sphere 52. The integrating sphere has a plurality of input ports 44.1, 44.2 through 44.N, and an output port 46. In an alternative embodiment, a single input port may be used, and additional output ports can also be used. The integrating sphere 52 may be any integrating sphere, and any other integrating device can also be used. Typically, an integrating sphere includes a hollow spherical interior surface made from a material or having a surface coating that diffusely reflects light striking its interior surface with a reflectivity often exceeding 99 percent for wavelengths of interest.

Light enters the integrating sphere 52 through relatively small openings comprising its input ports 44.1, 44.2 through 44.N, and exits the output port 46 as substantially integrated light. The input ports 44.x and the output port 46 are typically positioned on the sphere 52 such that the output port will only pass light reflected from an inner surface of the sphere and will not pass light directly from an input port 44 to the output port 46.

The integrating sphere 52 provides substantially integrated light at its output port 46. Substantially integrated light means light having substantially uniform intensity and distribution of light flux across a light beam, and is sometimes referred to as flat light. The light output of the integrating sphere is also sometimes called a Lambertian reflection or a Lambertian glow. This is due to the integrating characteristics of the diffuse reflective surface of the interior of the integrating sphere 52. The integrating sphere 52 can provide the substantially uniform light flux across the output port 46 without using one or more lenses, although lenses or other optical elements can be used if desired.

The illumination device 40 further includes an array 42 of light-emitting devices, illustrated in FIGS. 3A and 3B as a plurality of semiconductor light emitting devices 42.1, 42.2 through 42.N. The light-emitting devices of the array 42 may be semiconductor devices, such as a light-emitting device commonly known as LEDs, lasers, combinations thereof, or other suitable light-emitters. LEDs are economical, provide a high light intensity, turn on and off quickly, and are available in a variety of colors that include visible, ultraviolet, and infrared wavelengths. Brightness of the light-emitting devices of the array 42 may be varied by varying the current through the light-emitting devices.

In certain embodiments, the semiconductor light-emitting devices 42.1, 42.2 through 42.N each emit a light that peaks about a frequency. In an embodiment, at least two of the light-emitting devices peak about the same frequency. In another embodiment, the semiconductor light-emitting devices peak about different frequencies. For example, the light-emitting device 42.1 emits light frequencies that peak about a first frequency, and the light-emitting device 42.2 emits light frequencies that peaks about a second frequency. By way of further example, the first frequency may be associated with a red color and the second frequency may be associated with a blue color. In another embodiment, at least one of the light-emitting devices emits light that strongly peaks about a single frequency, such as a main emission peak that is not more than approximately 130 nm wide. In other embodiments, the array 42 includes light-emitting devices that emit light frequencies that peak about a single frequency of interest. Such frequencies may be selected for use with a particular stain or fluorescence. In a further embodiment, there are redundancies in the peak frequencies of the light-emitting devices selected for the array 42, allowing control of light intensity at the frequency by turning on a selected number of the light-emitting devices 42.1, 42.2 through 42.N. In another embodiment, the array 42 may include light-emitting devices 42.1, 42.2, and 42.3 that, respectively, emit light frequencies commonly associated with red, blue, and green. A color image of the tissue sample 26 may be acquired by digitally combining images captured by sequentially illuminating the tissue sample under red, blue, and green light from the respective light-emitting devices 42.1, 42.2 through 42.3 (or other suitable light combinations such as cyan, yellow and magenta, or light wavelengths selected to highlight particular features such as the relative presence of hemoglobin and deoxyhemoglobin, or otherwise as desired). In a still further embodiment, at least one of the light-emitting devices of the array 42 emits light having a broad range of frequencies and a plurality of peak frequencies, such as emitted by a white light LED.

The illumination device 40 also includes at least one light guide, such as an optical fiber, and, typically, includes a fiber optic bundle illustrated as a fused fiber optic bundle 54. The fiber optic bundle 54 does not need to be fused, and, indeed, other light transmission guides and systems may be used if desired. The fiber optic bundle 54 receives at its receiving end 48 the substantially integrated light from the integrating sphere 52 from the output port 46. The bundle 54 transmits the substantially integrated light to an output end 49, which may be directed toward a target, such as the tissue sample 26. The fused fiber optic bundle may be tapered as an expanding or diminishing cone. The optical fiber may include a randomized fiber optic cable, the randomization providing additional integration to the substantially integrated light.

An alternate embodiment can include an integrating cylinder, integrating cube, or any hollow body having an adequate diffuse reflectivity, typically greater than 98%.

The illumination device 40 further includes the controller 60 shown in FIG. 2 that turns the light-emitting devices 42.1, 42.2 through 42.N on and off, either individually or a plurality. The controller 60 may also vary a brightness of the light emitted by one or more of the light-emitting devices 42.1, 42.2 through 42.N semiconductor light-emitting devices by varying the current through the device. The controller 60 may be any device known in the art that controls semiconductor light-emitting devices, and typically comprising a microprocessor. The microprocessor may be coupled with or be incorporated into a computer that operates the microscope 21, allowing coordination between flashing one or more of the light-emitting devices 42.1, 42.2 through 42.N and capture of an image by a camera coupled to the microscope 21. The controller 60 may allow a user to individually control a brightness of the light emitted by one or more of the light-emitting devices 42.1, 42.2 through 42.N.

An embodiment for use with transmitted microscopy may be constructed using eight LEDs 42.1-42.N mounted to a frame and configured to emit light into the integrating sphere 52 through input ports 44.1-44.N. Two of the LEDs emit a blue light, two emit a red light, and two emit a green light. The remaining LEDs emit light having frequencies that peak about a single frequency selected for use with a selected staining agent, marker, or other frequency-specific target. Other configurations and combinations of numbers and colors of ports and light sources can also be used if desired, including that the number of light sources does not have equal the number of light ports.

The integrating sphere 52 as shown has an inside diameter of 1.5 inches, and output port 46 having an inside diameter of 0.5 inch, and eight input ports 44.1-44.N arranged around a circumference of the sphere. The input ports 44.1-44.N include openings in the sphere 52 dimensioned to allow light emitted from the seven LEDs 44.1-44.N to enter the interior of the sphere. The fused fiber optic bundle 54 has a rigid stick-like structure, an outside diameter of 0.5 inch, and a length of 0.75 inch. The input end 48 is optically coupled with the sphere by placing the input end placed proximate to the output port 46. The output end 49 of the fused fiber optic bundle 54 is orientated toward, and placed a selected distance from, the tissue sample 26 such that a light beam from the output end appropriately illuminates the tissue sample and fills the numerical aperture of the lens 22. Since the light beam outputted from the output end 49 is at least 0.5 inch in diameter, the diameter of the optic bundle 54, sufficient light is provided to fill most any objective selected to view the tissue sample 26. No lenses, filters, diaphragms, or shutters need be involved in delivering illumination to the microscope 21 and tissue sample 26, although such could be added if desired.

In use, a brightness level of one or more selected LEDs from the array 42 can be determined by taking test images with the microscope 21. Once brightness levels are established, the microscope may be used to acquire images of the tissue sample 26 and other tissue samples on the slide 28 by flashing or pulsing one or more LEDs of the array 42 at the determined brightness levels.

In one embodiment the illumination system 30 provides a selectable color illumination, the selectable color illumination allowing enhanced contrast with features of specimens being viewed, low power requirements, the intensity of the illumination light beam (or light flux across the light beam) will be uniform across the field of view for any selected objective magnification, and the numerical aperture of the illumination light beam provided to the tissue sample 26 will be adequate to fill the numerical aperture of any selected objective lens.

All terms used herein, including those discussed above in this section, are used in accordance with their ordinary meanings unless the context or definition clearly indicates otherwise. Also unless expressly indicated otherwise, the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

The scope of the present systems and methods, etc., includes both means plus function and step plus function concepts. However, the terms set forth in this application are not to be interpreted in the claims as indicating a “means plus function” relationship unless the word “means” is specifically recited in a claim, and are to be interpreted in the claims as indicating a “means plus function” relationship where the word “means” is specifically recited in a claim. Similarly, the terms set forth in this application are not to be interpreted in method or process claims as indicating a “step plus function” relationship unless the word “step” is specifically recited in the claims, and are to be interpreted in the claims as indicating a “step plus function” relationship where the word “step” is specifically recited in a claim.

Although the present disclosure has described in considerable detail various embodiments and aspects, other embodiments and aspects are possible. Therefore, the spirit or scope of the appended claims should not be limited to the description of the embodiments contained herein.

1. An illumination apparatus comprising:
a light-integrating device comprising at least one light input port, at least one output port, which device that receives light at the at least one input port and outputs a substantially integrated light at the at least one output port;
a plurality of light-emitting devices that each emit light having frequencies that peak about a single frequency, the light-emitting devices each being optically coupled to the at least one input port;
at least one light guide that receives the substantially integrated light from the at least one output port and provides it to a target; and
a controller that controls the illumination emitted from at least one of the plurality of light-emitting devices.

2. The illumination apparatus of claim 1, wherein the light-integrating device includes an integrating sphere.

3. The illumination apparatus of claim 1, wherein the light-integrating device provides the substantially uniform light flux without using a lens.

4. The illumination apparatus of claim 1, wherein the frequencies of light emitted by at least two of the light-emitting devices strongly peaks about the single frequency.

5. The illumination apparatus of claim 4, wherein the frequency of the light emitted by the at least one light-emitting device has a main emission peak that is not more than approximately 130 nm wide.

6. The illumination apparatus of claim 1, wherein the frequencies of light emitted by a first one of the light-emitting devices peaks about a first frequency and the frequencies of light emitted by a second one of the light-emitting devices peaks about a second different frequency.

7. The illumination apparatus of claim 1, wherein the single frequency of the light emitted by at least one of the light-emitting devices is not visible to a human eye.

8. The illumination apparatus of claim 1, wherein the single frequency of the light emitted by at least one of the light-emitting devices is visible to a human eye.

9. The illumination apparatus of claim 1, wherein the at least one light-emitting device includes a light-emitting diode.

10. The illumination apparatus of claim 1, wherein the at least one light-emitting device includes a light-emitting laser.

11. The illumination apparatus of claim 1, wherein the light guide includes a fiber bundle.

12. The illumination apparatus of claim 11, wherein the fiber bundle includes a fused fiber bundle.

13. The illumination apparatus of claim 11, wherein the fiber bundle includes a randomized fiber optic cable.

14. The illumination apparatus of claim 1, wherein the illumination system is incorporated into a microscope.

15. A method of providing a target illumination light to a microscope, comprising:
generating a signal to activate a plurality of semiconductor light-emitting devices to emit light, each light-emitting device emitting light having frequencies that peak about a single frequency,
activating the plurality of semiconductor light-emitting devices to emit light;
substantially integrating the light from the plurality of semiconductor light-emitting devices;
outputting the substantially integrated light;
transmitting the outputted substantially integrated light to a target using at least one optical light guide; and
de-activating the plurality of light-emitting devices.

16. The method of claim 15, wherein the frequencies of light emitted by a first one of the light-emitting devices peaks about a first frequency and the frequencies of light emitted by a second one of the light-emitting devices peaks about a second different frequency.

17. The method of claim 15, wherein the at least one light-emitting device includes a light-emitting diode.

18. The method of claim 15, wherein the at least one light-emitting device includes a light-emitting laser.

19. The method of claim 15, wherein the substantially-integrating is performed without using a lens.
